(19) United States
(12) Patent Application Publication
(10) Pub. No.: US 2007/0276871 A1
(43) Pub. Date: Nov. 29, 2007

(54) SYSTEM FOR STORING, DISPLAYING, AND NAVIGATING CONTENT DATA REGARDING MARKET DRIVEN INDUSTRIES

(75) Inventors: Michael Fu, San Jose, CA (US); Harold Sun, Tigard, OR (US); Unni Narayanan, Sunnyvale, CA (US); William Ward Carey, Hillsborough, CA (US); Phani Saripella, Santa Clara, CA (US)

Correspondence Address: JONATHAN A. SMALL;JAS IP CONSULTING, 343 SECOND STREET, SUITE F, LOS ALTOS, CA, 94022, US

(73) Assignee: PRIMARY GLOBAL RESEARCH, LLC, Mountain View, CA (US)

(21) Appl. No.: 11/750,661

(22) Filed: May 18, 2007

Related U.S. Application Data
(60) Provisional application No. 60/802,642, filed on May 23, 2006.

(51) Int. Cl. G06F 7/00

(52) U.S. Cl. 707/104.1

(57) ABSTRACT

A model and system employing the model provides an organized structure for storing, displaying, and navigating content data regarding instruments for market driven industries (i.e., securities). A Market Research Model (MRM) paradigm is used to represent elemental concepts, a plurality of specific classes of entities form the MRM, and an interface is used to assemble, maintain, and interact with the model. Information may be added to the model by a research provider and provided to an end user on a subscription basis. The user is provided with an interconnected, navigable model of an item of interest for research and decision-making support.

### CROSS-REFERENCE TO RELATED APPLICATIONS

The present invention is related to and claims priority from copending U.S. Provisional Patent Application titled “User Interface System for Providing Content on Market-Driven Industries”, Ser. No. 60/802,642, filed May 23, 2006, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention is related to research tools used to analyze securities, and more specifically to methods and apparatus for organizing and accessing various content about market-driven industries to facilitate securities-related decision making processes.

2. Description of the Prior Art

There exist today many methods for analyzing investment opportunities. One method of analysis used by security analysts, investors, investment managers, etc. is to gather public, non-public, and non-material information about a company, and industry or the like from a variety of sources, and interrelate that information to form a model, often referred to as a data mosaic, in order to determine the underlying value of a company's securities, trends in that security's value, and to assist with investment decisions with regard to that security. The data mosaic may follow a formal written structure, be a more conceptual mental model, or take some form between these two. The theory is that the value of a security is determined by many related factors effecting the business, the market in which the business operates, etc. which must be considered together.

The ultimate purpose of a data mosaic is to provide an organized view of facts and opinions in order to answer one or more questions, such as will the value of a particular security rise or decline. A data mosaic may be built with a specific query in mind, the content which populates the mosaic typically either tending toward a positive, neutral, or negative response to the query. Alternatively, a data mosaic may be a generalized collection of information about a company, business sector, etc., with information added as it becomes available or of interest. A snapshot of the data mosaic can then provide a perception of the one or more aspects of the company, such as the value of a security, at time of viewing. Thus, simple models often aggregate the positive content together, the neutral content together, and the negative content together. An analyst can then effectively develop a recommendation based on weighing the various content. Historically, the collection, aggregation, and weighing of content has been a manual and labor-intensive process, with little reusability. Indeed, the success and reputation of an analyst could depend on the completeness and accuracy of her data mosaic.

As the complexity of the market-driven industries about which the user (such as portfolio managers, securities analysts, investors, etc.) gathers content increases, so does the very process of gathering, sorting, and analyzing that content. Not only has complexity increased, but due to the ready availability of information on the internet and other sources, the volume of information has dramatically increased in recent years.

More specifically, the process of populating and using a data mosaic involves four classes of challenges. First, the formation of a data mosaic may be incomplete and/or based on inconsistent understandings of the industry. As mentioned, the reputation of a securities research provider often hinges on the depth and quality of his or her industry contacts and experts who provide facts, options, and other content to populate a data mosaic. However, there has heretofore not been a consistent, methodological tool providing an organized view of such facts, opinions, and other content allowing a user to see Connections, missing elements, inconsistencies, etc.

Second, managing the organized introduction of content into the data mosaic has proven to be a challenge. When new content is to be added, the securities analyst is faced with the questions of how and where it should be inserted. This choice is often specific to the manner in which an analyst builds their data mosaic. However, typically, the content is categorized as positive, neutral or negative. It is often associated with a particular contact (for example so that that contact's reputation may also be factored into the analysis). And the content may exclusively relate to a particular question that the user is attempting to address. Heretofore there has not been a systematic, user-friendly method for introducing new content into a data mosaic.

Third, once content has been introduced into the data mosaic, maintaining that data mosaic becomes a challenge. For example, most content is time sensitive. Content may be entered into the mosaic which represents an expert's opinion at one point in time, and different content added to the mosaic at a later time representing that expert's revised opinion. Or, content may relate to a particular upcoming event, and once the event takes place that particular content may no longer be relevant. Heretofore there have been no effective tools and processes for maintaining a data mosaic.

Fourth, interacting with end users at the proper level of abstraction has been a challenge. For example, many of the content items comprising a mosaic are complex or generic concepts which, by themselves, do not provide adequate assistance to a user. Often, one form of user is an industry specialist, who routinely examines a particular industry sector. Certain items of content will have great meaning and value to this level of user. However, the terminology used, the complexity of the data they represent, the breadth of their impact, etc. may mean that these content items are not, by themselves, useful to other classes of users, such an individual investor. Heretofore, there has been lacking an effective system and method for communicating and permitting interaction with complex ideas sequenced and organized in a way which makes sense across a class of users (e.g., from research analyst to an end user).

Additionally, a data mosaic may be comprised of many individual but interrelated items of content. The volume of content and the sometimes subtle nature of the interrelationships therebetween may mask how the content fit together into a cohesive model. Furthermore, when one item of content leads a user to a query or an interest in viewing some potentially related item of content, the search for that related content has been purely manual. Heretofore, there has been lacking an effective interface to assist with viewing items of content within a data mosaic, viewing relationships between that content, and permitting navigation (traversal) through the mosaic by way of those relationships.

### SUMMARY OF THE INVENTION

Accordingly, the present invention is directed to systems and methods for supporting the research processes of equity investors, for example in assisting with the formation of data mosaics covering complex, market-driven industries. The invention comprises multiple elements, including: (1) a Market Research Model (MRM), a normative model used to represent essential concepts (e.g., facts, opinions, relationships, etc.) encountered during the formation of data mosaics; (2) a plurality of specific types of elements within the MRM both primitive (Entities) and complex (Patterns) in nature; and (3) an interface used to assemble, maintain, and interact with the data mosaic. Together, these elements provide a set of methodological tools providing: an organized view of a data mosaic highlighting facts, opinions, and other content about a research topic, allowing a user to see connections, missing elements, inconsistencies, etc.; a systematic, user-friendly method for introducing new content into a data mosaic; effective tools and processes for maintaining a data mosaic; and an effective system and method for communicating and permitting interaction with complex ideas sequenced and organized in a way which makes sense across a class of users (e.g., from research analyst to an individual investor). These elements may be woven together, for example, into a system by which a research provider may enumerate, aggregate, annotate, rank, organize, connect, and provide content to users, for example on a subscription basis.

According to one aspect the present invention, the MRM is an assembly of elements both primitive (Entities) and complex (Patterns). Entities are simple, discrete elements of information within the MRM. Examples of Entities in the MRM include, but are not limited to: producers/resellers (e.g. companies in a given industry), content sources (e.g. industry experts who can comment on the said companies), and content (industry expert statements (or Impact Statements), company facts, comments, text files, spreadsheets, presentations, etc.).

According to another aspect of the present invention, a set of Patterns may be established within the MRM. Patterns are complex or high-level Entities. A class of Pattern is the Aggregation, which are sets, ordered or unordered, of Entities, Patterns, and other annotations. Aggregations may also have internal structure, e.g. when Link Entities or other ordering information are included within the definition of the specific Aggregation. Examples of ordered Aggregations include, but are not limited to: the Value Chain Model (VCM), Consultations, and Favorite ists. Aggregations without Link entities or other ordering information are simply collections or groupings of related objects; examples of unordered Aggregations include, but are not limited to: Categories/Watch Lists.

Examples of Aggregations include, but are not limited to: categories (watch lists), consults, favorites, and the Value Chain Model (VCM) each discussed in more detail herein. Another highly useful Pattern is the Abstraction. Abstractions are Aggregations wherein a set of lower-level Entities and Patterns are abstracted or subsumed by additional Content or other data included in the set. Abstractions represent higher-level conceptual elements of information, or a synthesis of lower-level, more granular concepts and/or Content. An example of Abstraction are the Plank and Thesis Patterns, discussed further herein.

Relationships between elements in the MRM may be represented by Connections assigned within the MRM in a manner allowing navigation from one element to another, for example by way of a hyperlink, graphical map, etc. Patterns may themselves be linked by Connections for inter-Pattern navigation. Elements comprising a Pattern may also be linked to one another for intra-Pattern navigation.

Patterns may be used to simplify or speed up the process of building and maintaining a data mosaic, assist in viewing and abstracting data from a data mosaic, and for creating re-useable templates for interactions between a research provider and/or a user and the data mosaic.

The MRM may contain any number of the above Entities and Patterns, connected in flexible and useful ways. In addition, within the MRM, a specific Pattern referred to as a Value Chain Model (VCM) may be defined to provide a normative yet flexible model which captures how goods and services flow from suppliers to customers in a target industry.

The MRM may be as simple or as detailed as is necessary for supporting a particular analysis or user. Using the MRM, systems supporting the investment research process can provide an environment which gives a user freedom to explore the domain freely while providing a framework wherein ideas and data are abstracted, aggregated, organized, and filtered to be relevant to the user's research processes. The MRM promotes efficient navigation and organization of relevant content, preventing the user from becoming overwhelmed by less pertinent information, and assisting with guiding a user to information being sought. To achieve this, the Connections in an MRM allow traversal between related Entities, Aggregates, Abstractions, and other Patterns.

A data mosaic may contain hundreds of (or more) individual data points about a given industry. Furthermore, investors may be pursuing multiple investment ideas at once, i.e. simultaneously forming a plurality of data mosaics. In order to simplify managing and keeping the set of data mosaics up to date, the MRM allows end users to annotate any Entity or Pattern with their own data (e.g., text notes, documents, spreadsheets, presentations, etc.) Furthermore, Patterns (e.g. Product/Reseller Watch List, Favorites, Consultations, etc.) may be defined which function as templates to assist with and standardize organization and management of research within a data mosaic.

With the ability to represent both Entities and Patterns, the MRM provides a framework for expressing and annotating highly complex ideas, thus allowing a research provider the ability to assemble disparate content into a cohesive data mosaic. With the ability to traverse between Entities, Aggregations, Abstractions, and other Patterns, the MRM provides a user with the ability to interact with the mosaic at higher levels of abstraction (and thus more effectively) than heretofore available.

The above is a summary of a number of the unique aspects, features, and advantages of the present invention. However, this summary is not exhaustive. Thus, these and other aspects, features, and advantages of the present invention will become more apparent from the following detailed description and the appended drawings, when considered in light of the claims provided herein.

### BRIEF DESCRIPTION OF THE DRAWINGS

In the drawings appended hereto like reference numerals denote like elements between the various drawings. While illustrative, the drawings are not drawn to scale. In the drawings:

FIG. 1 is an exemplary embodiment of a system within which the present invention may operate;

FIG. 2 is an illustration of an instantiation of an Market Research Model (MRM) according to an embodiment of the present invention;

FIG. 3 is an illustration of an instantiation of a generalized Value Chain Model (VCM) according to an embodiment of the present invention;

FIG. 4 is an illustration of a specific value chain model which forms a portion of FIG. 2;

FIG. 5 is an illustration of an exemplary computer user interface for a Consultation Entity according to an embodiment of the present invention;

FIG. 6 is an illustration of an exemplary computer user interface for a Consultation List Pattern according to an embodiment of the present invention;

FIG. 7 is an instantiation of a Market Research Model (MRM) illustrating an arrangement of Planks according to one embodiment of the present invention;

FIG. 8 is an illustration of an exemplary computer user interface for a Favorites/Categories Pattern for Experts according to an embodiment of the present invention;

FIG. 9 is an illustration of an exemplary computer user interface for a Producer/Reseller Aggregation according to an embodiment of the present invention;

FIG. 10 is an illustration of an exemplary computer user interface for an Experts Aggregation according to an embodiment of the present invention;

FIG. 11 is an illustration of an exemplary computer user interface for an Ecosystem Aggregation (XLNX) according to an embodiment of the present invention;

FIG. 12 is another illustration of an exemplary computer user interface for an Ecosystem Aggregation (ALTR) according to an embodiment of the present invention;

FIG. 13 is an illustration of an exemplary computer user interface for a Producer/Reseller Watch List according to an embodiment of the present invention;

FIG. 14 is an illustration of another exemplary computer user interface for a Producer/Reseller Aggregation (AAPL) according to an embodiment of the present invention;

FIG. 15 is an illustration of another exemplary computer user interface for an Ecosystem (AAPL) according to an embodiment of the present invention;

FIG. 16 is an illustration of another exemplary computer user interface for a Producer/Reseller Aggregation (AAPL-→STX) illustrating a nested aspect of navigating an MRM according to an embodiment of the present invention; and

FIG. 17 is an illustration of a hierarchy diagram and user interface for a sample Thesis Plank according to an embodiment of the present invention; and

FIG. 18 is an illustration of another exemplary computer user interface for a Thesis according to an embodiment of the present invention; and

FIG. 19 is an illustration of a Content Source biography pop-up display within the context of the user interface for a sample Thesis Plank according to an embodiment of the presentation invention;

FIG. 20 is an illustration of the iterative scheduling process for a Consultation according to an embodiment of the present invention; and

FIG. 21 is an illustration of a system implementing support for the iterative scheduling process for a Consultation according to an embodiment of the present invention.

### DETAILED DESCRIPTION OF THE INVENTION

The following detailed description is divided into two main sections. The first of these sections discloses the definition of the Market Research Model. The second section describes exemplary Patterns and Interfaces which may be implemented as part of a system supporting the formation of data mosaics and investment ideas. Exemplary embodiments of the invention are also described.

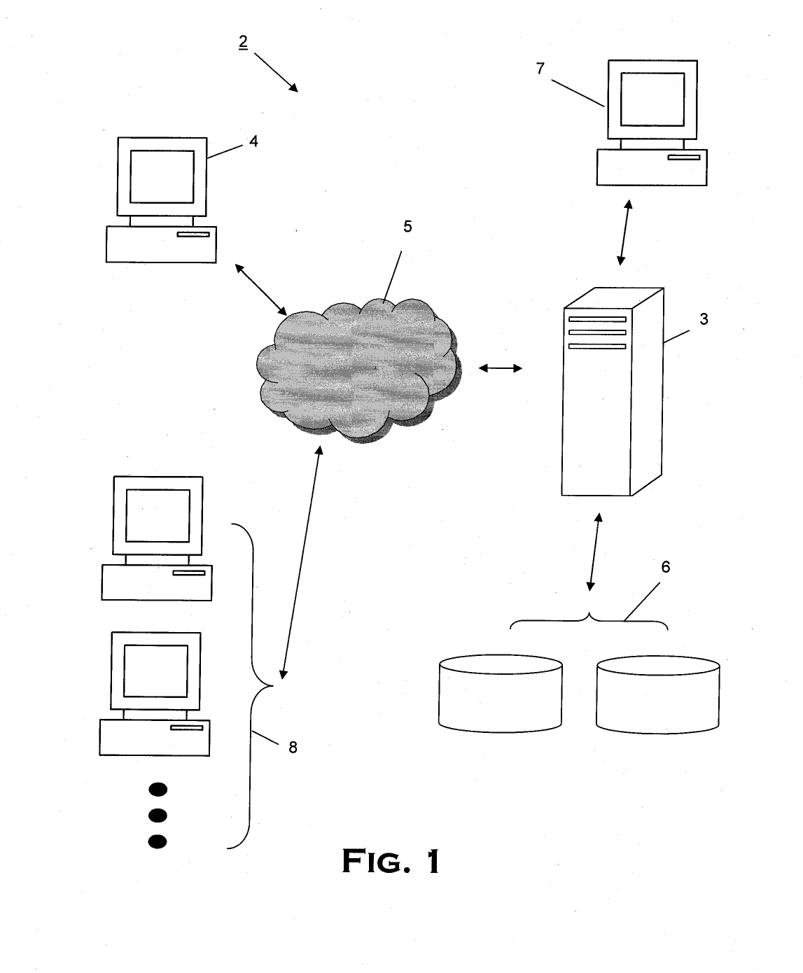

In order to provide context for the discussion which follows, FIG. 1 is an exemplary embodiment 2 of a system within which the present invention may operate. While other such arrangements are within the scope of the invention as disclosed and described herein, system 2 comprises a host server 3 connected to an end user 4 via a network 5 such as the internet. According to this embodiment, the host server is programmed by a research provider to provide information, annotations, connections between related entities, etc. about one or more investment topics to end user 4. End user 4 may, for example, be provided access to host server 3 on a subscription basis. End user 4 may also be permitted to modify records accessed via server 3, upload files to memory 6 associated with server 4, etc. Information provided to end user 4 may be generated by the host data service 7, e.g., host analyst or host research provider, providing access to host server 3, or by a third party data provider 8 such as an independent analyst or independent data service provider.

### The Market Research Model

The Market Research Model (MRM) is a paradigm supporting the collection, association, filtering, and viewing of content to support analyses of market-driven instruments, for example securities valuation and trend prediction. The MRM consists of Entities and Patterns (i.e. complex Entities). Different classes of Entities and Patterns correspond to critical, core concepts in the domain (i.e., key content related to the domain in which the market-driven industry operates). According to one embodiment of the present invention, the following are considered Entities:

1) Elements of the Value Chain Model;

2) Content Sources;

3) Content; and

4) Links.

The Value Chain Model (VCM) represents how goods and services flow between parties, such as from producers to consumers in an industry (i.e., the Value Chain). Typically, a VCM is an ordered Aggregation consisting of Producer/Reseller Primitive Entities and an optional set of other primitive entities. The entities within a VCM may also be ordered according to a variety of optional Link entities which have particular semantic meaning (e.g. Supplier/Customer, Produced By, Strategic Partner, etc.) in the MRM. Having a minimal instantiation of a VCM is essential for providing context to individual data points (as well as more complex concepts) in a larger mosaic and for organizing research on an investment idea. It will be appreciated that use of the term Producer/Reseller is intended to be a compact way to represent a broad class of business relationships. It is not to be considered limiting, as customer, consumer, vendor, partner, supplier, distributor, consultant, and many other relationships between business parties are considered within the scope of that term. The VCM is discussed in greater detail below.

Content Sources (an Entity type) include, but are not limited to: private individuals, companies/corporations, industry and professional organizations, third-party data providers and aggregators, data feed services, publications, etc. As the name suggests, Content Sources are points from which content used to populate a data mosaic may be obtained. As will be discussed, the nature of the content source (e.g., experience, reputation, closeness to the industry in question, possible biases, etc.) may itself be a content element of a data mosaic (in addition to the content provided by that content source).

Content (also an Entity type) includes, but is not limited to the ideas, facts, opinions, etc. contained in: text documents, emails, presentations, spreadsheets, databases, recordings, transcripts, and summaries from the above Content Sources. Indeed, virtually any element of information, whether opinion or fact may be considered a Content Entity. Of particular note are industry expert statements, also known as Impact Statements, which are short textual statements elicited from industry experts during their conversations with the research provider.

Links are Connections between elements in the MRM. Any Entity or Pattern may be linked to any other Entity or Pattern. As will be explained further below, the establishment of links permits exploring the various content comprising the MRM by traversing from Entity to Entity within the MRM. However, links must be judiciously placed to guide the exploration process—the goal of the MRM is to facilitate an organization of large quantities of content. Providing too many links will result in unguided traversing of the MRM which may overwhelm the user with information.

Aggregations are a highly useful class of Pattern defined within the MRM. Specifically, Aggregations are sets, which may be ordered or unordered, of other Entities, Patterns, and other annotations. Aggregations may be ordered by some subset of the included Entities, Patterns, and other annotations, also known as the Ordering Subset. For example, elements of the Ordering Subset may be Link Entities or other annotations.

If the ordering subset is empty, then the Aggregation is considered a collection or non-ordered grouping of Entities and Patterns. An example of this latter case is the Producer/Reseller Watch List, an unordered collection of Producer/Resellers of interest to the end user.

Abstractions are ordered Aggregations which represent synthesized concepts about a group of Entities or Patterns. For example, a Thesis, which is an investment idea regarding a producer/reseller or group of producers/resellers based on a complex set of Entities in the MRM, is an Abstraction.

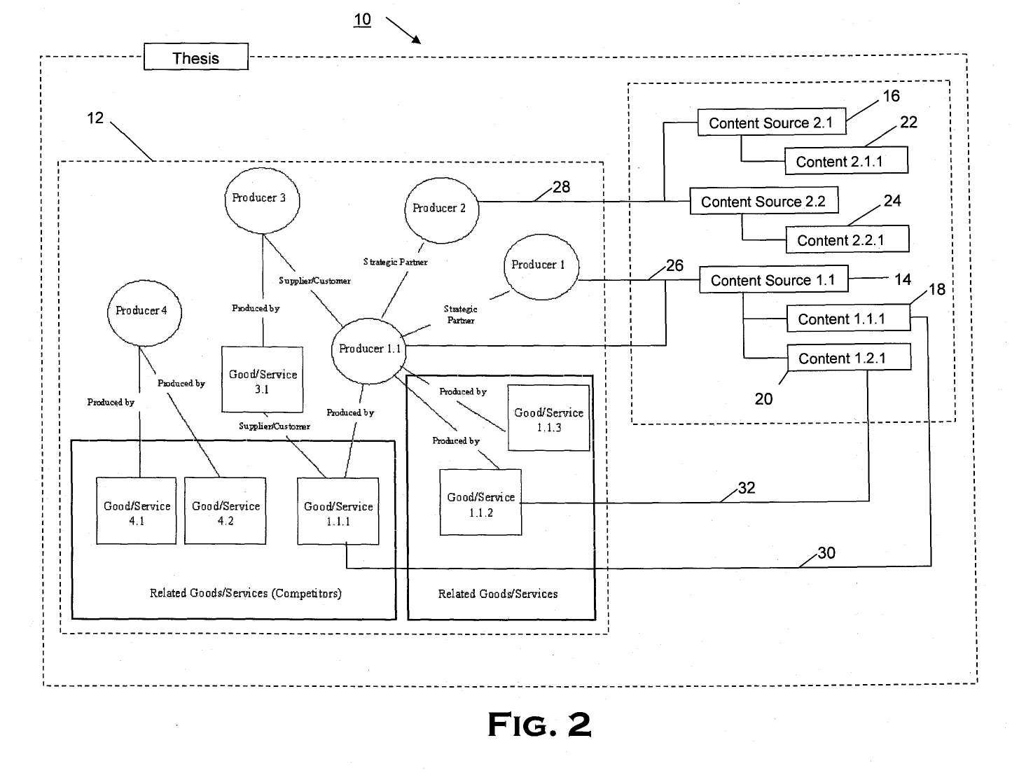

We to turn to an example of an MRM. FIG. 2 is an illustration of an instantiation 10 of an MRM. This instantiation 10 of an MRM includes a VCM 12 (discussed further below), content sources 14, 16, content items 18, 20, 22, 24, and a plurality of links, such as 26, 28, 30, 32. Virtually every instance of an MRM will contain different Entities and different links, so FIG. 2 is intended merely to provide the reader with a conceptual view of an MRM. We next discuss the various elements of the MRM.

### Value Chain Model

One critical requirement of providing context-sensitive support (that is, information relevant to a user's area of interest) is developing a representation of the domain (e.g., the industry) relating to the target of the mosaic which is adequate (within the limits of the system and its purposes) to support the formation and population (with content) of the mosaic. That is, it is important to have an adequate representation as a part of the MRM of at least relevant portions of the industry to which a security in question relates. A Value Chain Model (VCM) forms a minimum set of Entities for this purpose.

The content of the VCM includes required and optional content, summarized in table 1 as follows:

TABLE 1

| | |
|---|---|
| Required VCM | Producers/resellers of goods and services, at least one |
| content | Link between two of the Producers/Resellers |
| Optional VCM | Goods and services |
| content | Links between different Producers (e.g., |
| | supplier/consumer, strategic partnerships, etc.) |
| | Links between Producers and Goods/Services |
| | Links between different Goods/Services (e.g., |
| | competitive, grouped products, etc.) |
| | Groups of the above items |
| | Descriptors/modifiers for any of the above items |

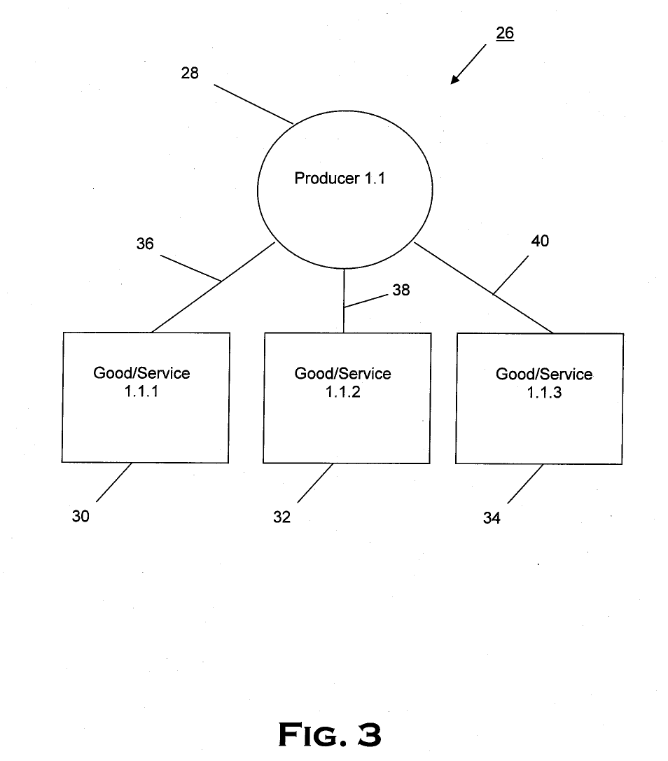

The model represents a Value Chain because each producer/reseller derives value from its predecessor producers/resellers in the form of goods and/or services. FIG. 3 displays an instantiation 26 of a VCM with a single producer 28, three examples of goods/services 30, 32, 34 produced by producer 28, linked by links 36, 38, and 40 indicating that goods/services 30, 32, 34 are produced by producer 28, respectively. That is, the tree structure of VCM 26 shown in FIG. 2 demonstrates that producer 28 produces good/service 30, 32, 34. Thus all of the Link Entities defined above are part of the ordering subset for the VCM.

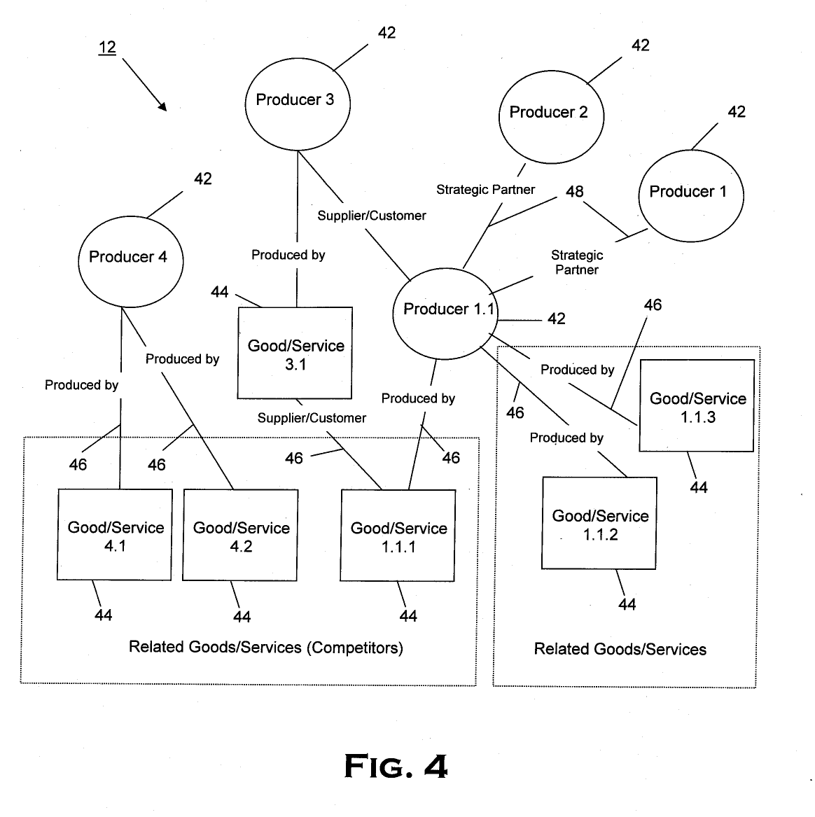

With reference now to FIG. 4, there is shown therein the value chain model 12 which forms a portion of FIG. 2. VCM 12 includes multiple producers 42, goods/services 44, links representing supplier/consumer relationships 46, and links representing other entity relationships 48. Among the relationships specified in FIG. 4 are:
Producer 1.1 produces good/service 1.1.1-1.1.3
Producer 3 produces good/service 3.1
Producer 4 produces good/service 4.1 and 4.2
Producer 1.1 is a division (i.e., sub-organization of) producer 1
Producer 2 is a strategic partner of producer 1.1
Producer 3 is a supplier for producer 1.1
Good/service 3.1 is consumed to produce good/service 1.1.1
Good/services 4.1, 4.2, and 1.1.1 are specifically related goods/service in that they compete in the same market
Good/services 1.1.2 and 1.1.3 are generally related

We note that there can be more than a single Value Chain Model instantiated within an MRM. Indeed, different Value Chain Models may be employed from the research provider and/or third-party sources, and linked as necessary between their constituent elements using the Link types described above. In another possible embodiment of the invention, the end user may be allowed to extend the existing VCMs within the MRM or to add his or her own VCM(s) as part of their MRM.

The MRM may be described more formally as follows, using traditional set theory notation. We begin by defining the following:
W is the World set, i.e. the space of possible descriptions of an MRM given a specific set of primitive Entities.
VCM is the Value Chain Model set, i.e. the space of possible descriptions of a VCM given a specific set of producers/resellers (PR), goods/services (GS), and relationships (REL) among them.
CS is the set of Content Sources relevant to the domain.
C is the set of Content relevant to the domain.
AG is the set of Aggregations (Patterns) relevant to the domain.
AB is the set of Abstractions (Patterns) relevant to the domain.
L is the set of links defined for a given MRM.

### Throughout this description we adopt the convention that lower-case elements with subscripts represent individual Entities in a set (e.g., pr₁ is an Entity member of the set of producers/resellers, PR).

```
W = VCM ∪ CS ∪ C ∪ AG ∪ AB, where
  VCM = PR ∪ GS ∪ REL ∪ GP, where
    PR = {pr₁, pr₂, ..., prₖ}, and
    GS = {gs₁, gs₂, ... gsₖ}, and
    GP = {gpᵢ}, where gpᵢ ⊂ VCM, and
    REL = (PR × PR) ∪ (PR × GS) ∪ (GS × GS) ∪ (PR × GP) ∪
        (GS × GP) ∪ (GP × GP)
      Note: GS, GP, and REL are optional in the Value Chain Model.
    CS = {cs₁, cs₂, ..., csₖ}, and
    C = {C₁, C₂, ..., Cₖ}, and
    AG = {ag₁}, where agᵢ ⊂ W
    AB = {ab₁, ab₂, ..., abₖ}
    VCM ≠ Ø
  L = W × W
```

### Specific Patterns and interfaces

In order to assist a user of the system in creating, navigating, and interpreting a data mosaic, the system permits the definition of Patterns (e.g., complex Entities). Pre-formulated Patterns (e.g., commonly used) may be provided to a user as well as tools allowing a user to create their own custom Patterns. Furthermore, there are a number of Interfaces (e.g., displays in a graphical user interface) which are particularly useful with certain Patterns. We next describe several specific embodiments of a system using the MRM, Patterns, and Interfaces according to the present invention.

Consultation Pattern and Consultation Interface

A first type of Pattern useful in describing an exemplary system is a Consultation Pattern (or simply a Consultation). A Consultation is the fundamental unit of work done by a user, the data service provider or a third party (or a combination thereof) when directly consulting (e.g., speaking with) a content source. It is the action associated with the collection of content. That is, the interaction between a user and a content source results in a set of Content regarding one or more producers or resellers, the market, etc. Formally, we define the Consultation Pattern as a class of Aggregate Entities consisting of:

A set of producers/resellers (PR);

One (or more) content sources (CS); and

A set of content about the producers/resellers (C)

### Or, more formally,

```
CONSULTATION = PR_{consultation} ∪ CS_{consultation} ∪ C_{consultation}
    where
    PR_{consultation} is the set of Producers/Resellers relevant to the
        Consultation, with PR_{consultation} ⊂ PR,
    CS_{consultation} is the set of Content Sources relevant to the Consultation,
        with CS_{consultation} ⊂ CS and CS_{consultation} ≠ Ø, and
    C_{consultation} is the set of Content relevant to the Consultation, with
        C_{consultation} ⊂ C, and further where
        the unordered tuple <csᵢ, cⱼ> ∈ L (the set of Links),
        CSᵢ ∈ CS_{consultation, and c}ⱼ ∈ C_{consultation}
```

A data service provider may initiate Consultations in the process of providing its service to end users. These consultations will populate the database(s) to which a user may subscribe. In addition, a user may request the data service provide to schedule a consultation. In such a case, the service provider may conduct a consultation on the user's behalf, or may put the user in touch with the Content Source for the consultation. The data service provider may create the instance of the Consultation for the consultation for the end user, or the end user may be provided an interface for creating a personal Consultation therefor. Consultations may be edited by the person creating the Consultation. Controls may also be provided to permit others to edit parts or all of a Consultation (this being true for other Entities in the MRM as well)

Over time, a user of the system builds up a set of Consultations which form some of the building blocks of a data mosaic. Interactions between the data provider service and the user can occur by passing/altering consultation elements back and forth.

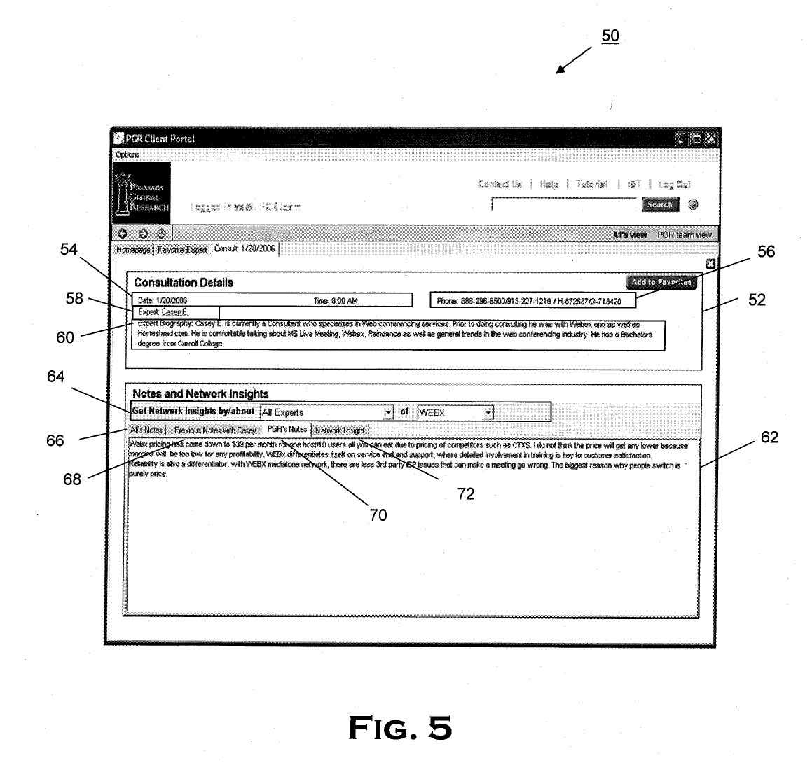

An exemplary computer user interface 50 for a Consultation is shown in FIG. 5. Interface 50 provides a number of regions for a user to enter or view data forming a Consultation. For example, a number of details can be specified or viewed in details window 52. Such details include the date and time 54 of the consultation, contact details 56 for the content source for the consultation, type 58 of the content source (e.g., expert, publication, etc.), and background 60 about the content source . . .

In addition to the details window 52 for the specific consultation, there may be provided a window 62 providing access to information related to the topic of the Consultation, such as for viewing previous Consultations, notes, etc. created by the user or others. Such a window may, for example, provide drop down lists 64 for filtering content to obtain desired information, and tabs 66, 68, 70, 72 for navigating between views. Should a user select a tab or an individual Entity displayed in window 62, a hyperlink may call up an appropriate associated Interface for that Entity.

Consultation List Pattern and Interface

The Consultation List Pattern defines a type of Aggregation Pattern listing Consultations available for the security in question. More formally, the Consultation list is defined as:

C_{List}={consultation₁, consultation₂, . . . , consultationₖ}
where each consultation is of a type which is made available to the end user (again, depending on permissions settings, some consultations may be visible and modifiable by the end user, visible but not modifiable by the end user, or not visible nor modifiable by the end user).

The Consultation List Pattern allows a user to view upcoming scheduled Consultations and prior Consultation history. That is, one aspect of the Consultation List Pattern is to function as a scheduler. When a user requests a Consultation from within a system, it shows up in their instantiation of the Consultation List Pattern and keeps them up to date with the status of the Consultation.

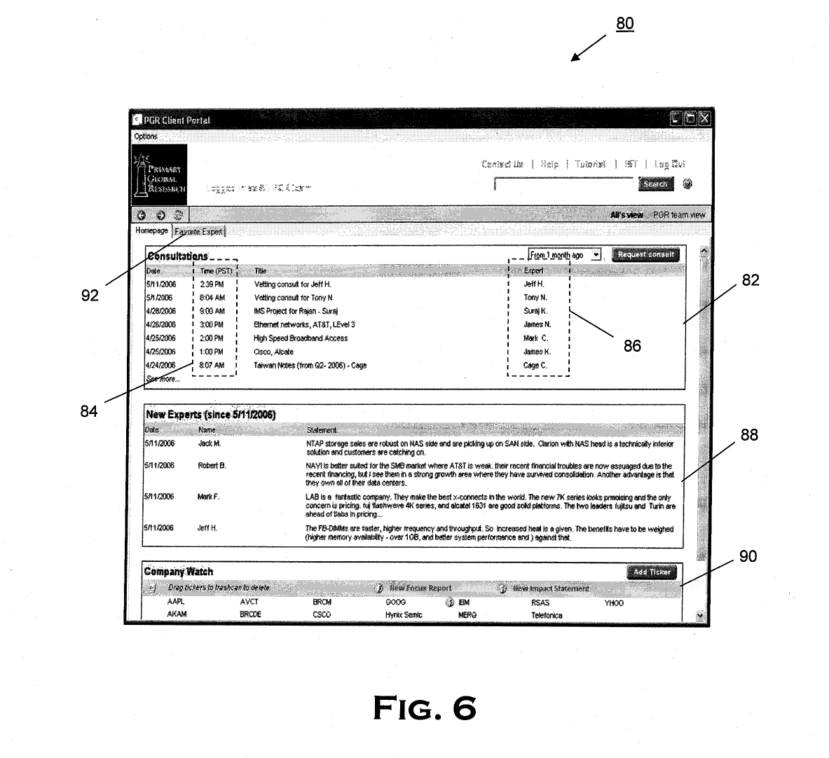

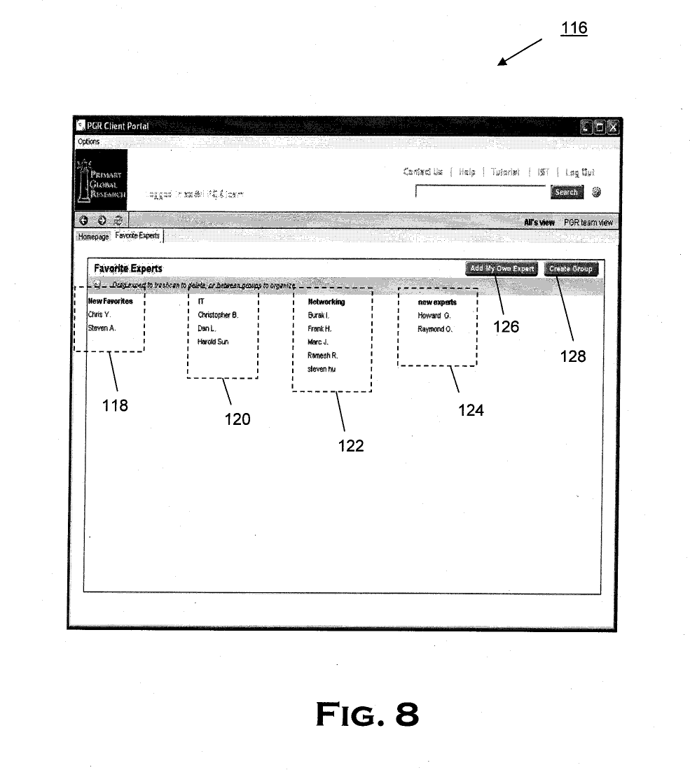

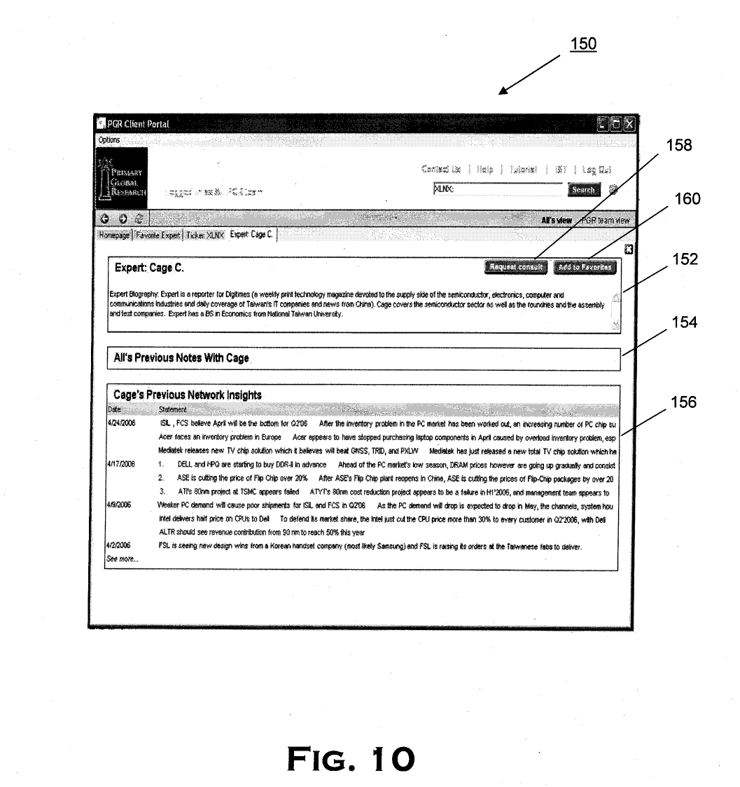

FIG. 6 displays a specific embodiment of the Interface 80 of an instantiated Consultation List Pattern. Here, the Consultation list 82 is displayed in tabular form, with the upcoming date/time of the Consultation 84, along with the expert name 86. A number of functionalities may be provided in such an interface. For example, clicking on an Expert's name can bring up the Expert Display (see FIG. 10 and associated discussion below) associated with that Expert. Furthermore, clicking on the Consultation's title may bring the user to the Consultation Display (see FIG. 5 and associated discussion below). A list 88 of added new experts, a Watch List 90 of watched securities (discussed in further detail below), and a list 92 of user-selected favorite experts (see FIG. 8 and discussion below) are among other elements and functionalities that may be provided in the Consultation List interface 80. These are just several example of the functionality which may be provided at the Consultation List interface, and other embodiments are within the scope of one of skill in the art.

Thesis Pattern and Display

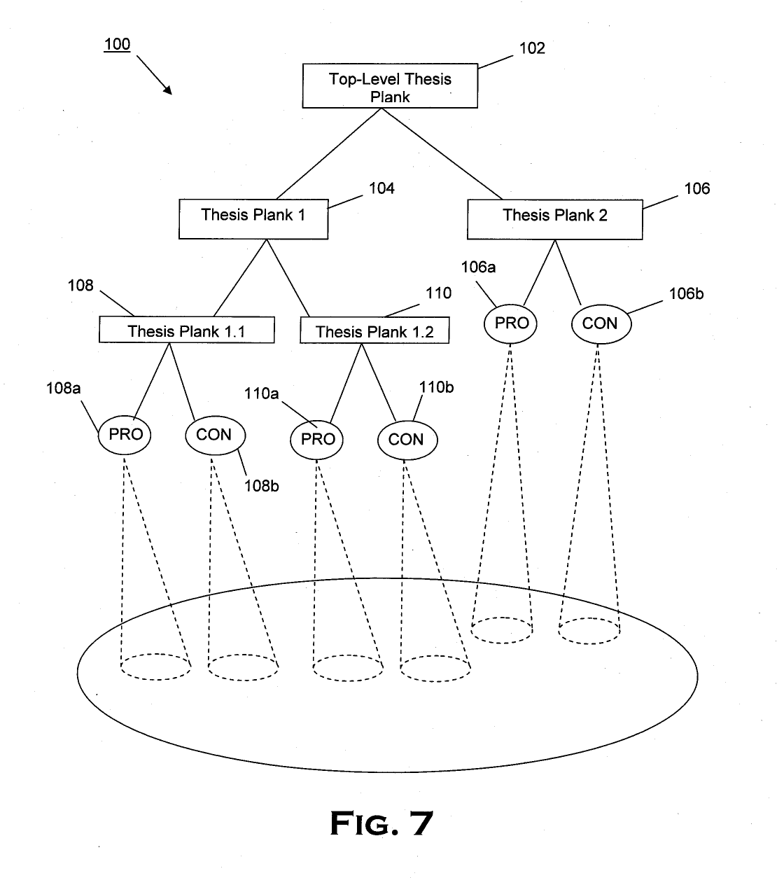

A Thesis Pattern is an Abstraction Pattern which can describe a complex investment idea (here called a Thesis). With reference to FIG. 7, an instantiation 100 of a Market Research Model according to one embodiment of the present invention is shown. FIG. 7 illustrates a Thesis 102 consists of a top-level investment statement (referred to as a plank) with a number of (and potentially a hierarchy of) sub-statements 104, 106 (sub-planks) and sub-sub-statements 108, 110 (sub-sub-planks) intended to support (or disprove) the top-level plank 102. Every plank is associated with two subsets of Entities in the MRM, labeled PRO (106a, 108a, 110a) and CON (106b, 108b, 110b). The PRO subset contains Entities which support the Plank, while the CON subset contains Entities which refute the Plank. For example, the PRO subset of a Plank can contain a set of VCM Entities, Content Sources, and Content which provide support for the Plank, while the CON subset of a Plank contains similar elements which refute the statement of the Plank.

One critical aspect of the Thesis is that it allows the user to conceptually, visually, and functionally drill down or drill up through the Abstraction layers (i.e. reasoning) about the Thesis. That is, an end user can start with the top-level Plank 102 and descend through the subordinate Planks 104-110 until he or she can view the desired information, such as the specific Content Sources (e.g. Experts) and Content (e.g. Impact Statements) which are in support or refutation of each Plank. Alternatively, a user may start from a specific Entity, such as a Producer/Reseller, and traverse upwards towards the top-level Plank of the Thesis. In general, a user may start at any point in the Abstraction hierarchy of Planks within the Thesis definition.

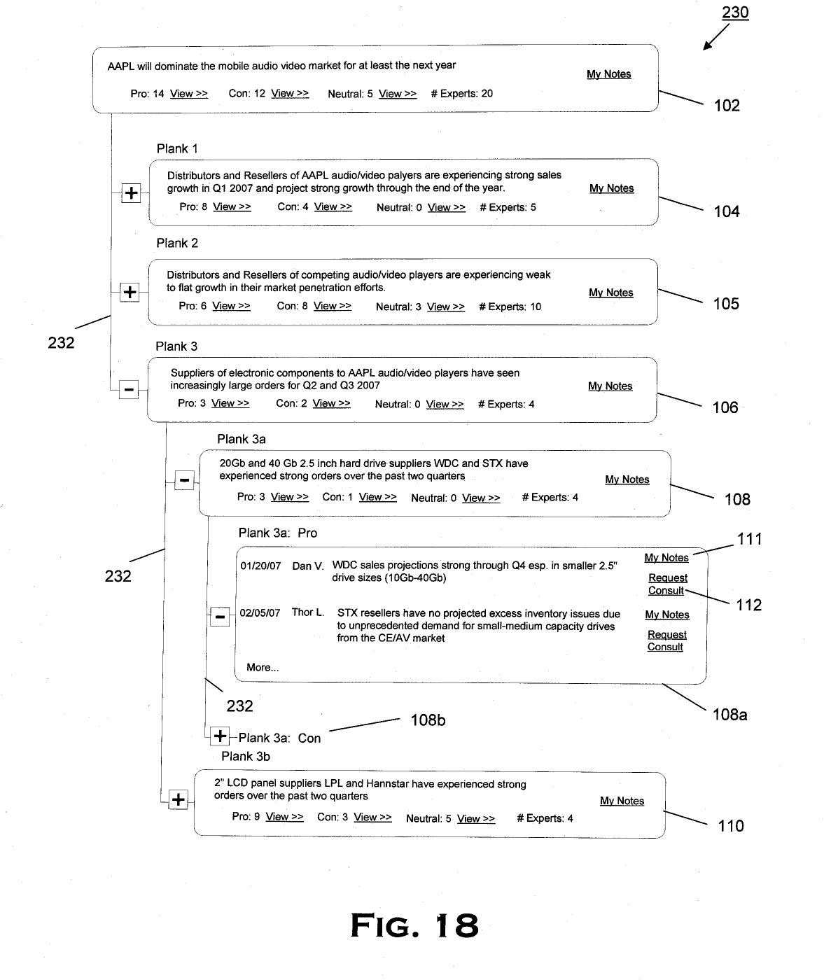

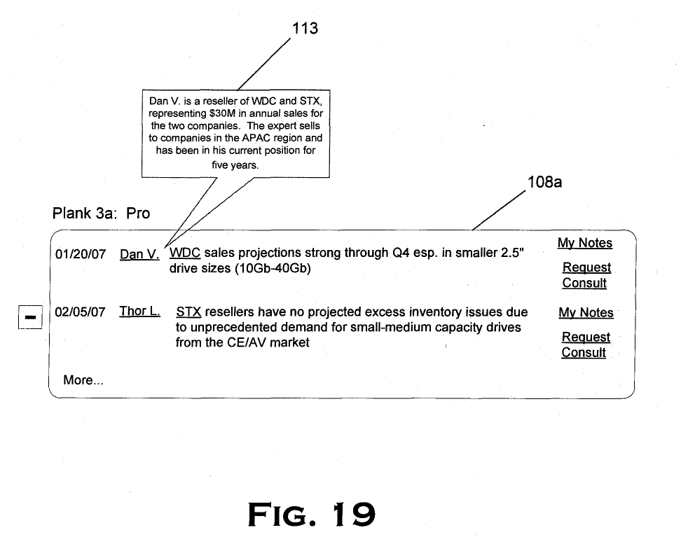

This navigation may be facilitated by a graphical user interface 230 as shown in FIG. 18. The abstraction hierarchy of the Thesis is represented by graphical links 232 between each parent Plank and its child Planks. For example, the end user starts at the highest abstraction level by seeing only the top-level Plank 102. By clicking on the top-level Plank, the user expands the display to include the immediate child Planks 104, 105, 106 of the top-level Plank. To drill down further into the abstraction hierarchy, the user can then click on Plank 106. This opens up that Plank's two subordinate Planks, Planks 108, 110. Finally, the end user can click on Plank 107 to display the lowest-level Content Entities 108a, 108b which alternately support (108a) and contradict (108b) Plank 108. From this lowest-level display the user can then view all of his or her Content associated with this Entity by clicking on My Notes 111 or even request a consultation with the Content Source by clicking on Request Consult 112. Also note that the end user may annotate every Pattern and Entity within the Thesis with his or her own content by clicking My Notes 111 and uploading text notes, comments, presentations, spreadsheets, etc. The end user may freely traverse within the context of the Thesis by clicking on the graphical elements corresponding to the top-level and subordinate Planks, leave the Thesis by clicking on one of the Content Sources (which displays all of the Content associated with the Content Source). Furthermore, the user may traverse beyond the scope of the Thesis by clicking on any of the underlined Producer/Resellers (e.g. WDC, STX, etc.) or Content Sources (e.g. Dan V., Thor L.). Mousing over a given Content Source, illustrated in FIG. 19, displays a pop-up dialog window 113 displaying the Content Source's biography, which explains the significance of the Content Source to the overall Thesis.

The Thesis Pattern is important for a number of reasons. For example, it allows Research Providers the ability to communicate complex investment ideas about an industry to an end user while providing all of the associated reasoning and data in a form which allows for efficient understanding of the investment idea. In addition, since the end user can annotate the Thesis object at any level of abstraction, the end user can adapt instantiations of a Thesis Pattern based on their own observations.

More formally, a Thesis Pattern is defined as:

```
THESIS = PLANKS ∪ ABₜₕₑₛᵢₛ ∪ AGₜₕₑₛᵢₛ ∪ VCMₜₕₑₛᵢₛ ∪ CSₜₕₑₛᵢₛ ∪
Cₜₕₑₛᵢₛ , where
  PLANKS ={plank₁, plank₂, ..., plankₙ}, where
    plankᵢ is the 5-tuple:
      <plank contentᵢ, PROᵢ, CONᵢ, user annotationsᵢ, parent plankᵢ> ,
        where plank contentᵢ is a statement or an element of W, and
        PROᵢ ⊂ ABₜₕₑₛᵢₛ ∪ AGₜₕₑₛᵢₛ ∪ VCMₜₕₑₛᵢₛ ∪ CSₜₕₑₛᵢₛ ∪ Cₜₕₑₛᵢₛ, and
        CONᵢ ⊂ ABₜₕₑₛᵢₛ ∪ AGₜₕₑₛᵢₛ ∪ VCMₜₕₑₛᵢₛ ∪ CSₜₕₑₛᵢₛ ∪ Cₜₕₑₛᵢₛ, and
        annotationsᵢ = {set of end users content}, and
        parent plankᵢ ∈ PLANKS or = Ø (for the top-level Plank);
  ABₜₕₑₛᵢₛ ⊂ AB is the set of Abstraction Entities associated with THESIS;
AGₜₕₑₛᵢₛ ⊂ AG is the set of Aggregation Entities associated with
THESIS;
VCMₜₕₑₛᵢₛ ⊂ VCM is the set of Value Chain Model Entities associated
with THESIS;
CSₜₕₑₛᵢₛ ⊂ CS is the set of Content Sources associated with THESIS;
and
Cₜₕₑₛᵢₛ ⊂ C is the set of Content associated with THESIS.
```

### Category/Watch List Pattern and Interface

A Category/Watch List is an unordered Aggregation (e.g. collection) which allows for a high-degree of interaction between the research provider and the end-user. From the research provider's perspective, a Category/Watch List Pattern contains items of interest to the end user, and thus may be used to flag and promote new Content Sources, Content, Theses, etc. which are relevant to the elements in the Category/Watch List. These elements may be made to automatically appear on the end-user's interface without additional tagging by the research provider. From the end-user's perspective, Category/Watch List Patterns are a powerful tool to manage the content from the research provider. Both the research provider and the end-user may be provided the ability to add and remove elements from a Category/Watch List Pattern.

The difference between a Category and a Watch List is that a Category can contain a heterogenous set of Entities or Patterns within the MRM. The Watch List is a specific subclass of Category which includes only a single class of Entities and/or Patterns (i.e. all elements in the Watch List are of the same type).

The power of the Category/Watch List Pattern lies in its capability of presenting, in a single focused area of an interface, a high-level summary of all recent relevant material from a research provider. The Company Watch 90 of FIG. 6 is an example of a Watch List Pattern interface. The interface for adding and removing elements from a Watch List Pattern may also vary significantly.

The Product/Reseller Watch List is another example of a Watch List Pattern. The Product/Reseller Watch List communicates the set of products/resellers entities of interest to the end-user as well as the existence of new Content and Content Sources linked to the Product/Resellers in the Watch List.

More formally, the Product/Reseller Watch List is defined as:

```
WATCH = PR_{watch} ∪ C_{watch} , where
    PR_{watch} ⊂ PR is the set of Producers/Resellers relevant to the Watch
    List, and
    C_{watch} ⊂ C , where
        the unordered tuple <Cᵢ, prⱼ> ∈ L,
        Cᵢ ∈ C_{watch} , and
        prⱼ ∈ PR_{watch}
```

As illustrated in the embodiment of Product/Reseller Watch List 90 shown in FIG. 6, the Product/Resellers may appear in tabular form. Other interface methods are also possible.

Categories and Watch Lists provide a means of automatically notifying end users when new Content or Content Sources that are relevant to their interests are available. For example, relevance may be defined as sets of Content and Content Sources which are directly linked to entities within the Watch List. For example, for the Producer/Reseller Watch List we consider only Content/Content Source pairs which are directly associated with the set of Producer/Resellers included within the Watch List. After computing the relevant Content/Content Source sets, there are a number of techniques of displaying them to the end user. As an example, an interface may highlight (e.g. text effects, icon, etc.) Producer/Resellers in the Watch List which are associated with recent Content/Content Sources according to the following formula, expressed in pseudocode:

```
if Content is linked to Product/Reseller
{
    if Content was entered over the past k days
    {
        if end-user has not traversed the link to the Content yet from the
        Product/Reseller
        {
            Highlight the Product/Reseller brightly
        }
        else
        {
            Highlight the Product/Reseller
        }
    }
}
```

The above is one high level example of implementing Watch List functionality. Other additional functionalities and formulae or algorithms may be developed to provide various aspects of Watch List functionality. Accordingly, this example is not intended to and does not limit the scope of the present invention. Each of the Product/Resellers listed in the Watch List area 90 may be hyperlinks such that clicking on any one of them takes the user to the Product/Reseller Interface for that Product/Reseller.

Favorites Pattern and Interface

The Favorites Pattern defines a class of ordered Aggregations which are used to group together selected Entities of a given class or classes by an end user. By creating instantiations of this Pattern, the end user or research provider can group, or define as “favorite,” a set of Content Sources, of Theses, etc.

More formally, a Favorites Pattern is defined as:

```
FAV_{class} = { ent₁, ent₂, ..., entₖ, order₁, order₂, ...orderₖ}, where
    entᵢ is merely an instantiation of an Entity class. That is, the multiple
    elements of the FAV_{class} may belongs to the same Entity or Pattern
    class, or may be a heterogeneous mix of such elements from different
    Entity and Pattern classes. orderᵢ is the set of ordering elements for
    the Pattern.
```

The Favorites Pattern allows end users to organize, easily display, and quickly access the set of Entities and Patterns which they find most helpful in their research processes. Much like the Producer/Reseller Watch List Pattern, the Favorites Pattern is also a way for an end user to communicate with a research provider, for example as a way for a research provider to discern the interests of the end user.

An exemplary embodiment 116 of a Favorites Pattern for Experts is shown in FIG. 8. According to this embodiment, a multi-level Favorites/Categories Pattern is shown; the top level Favorites Pattern is an Aggregation of other Favorites Patterns of Experts. The Favorite Experts are shown in groups 118-124, for example by technology sector. For convenience, each listed Entity and/or Pattern in the Favorites Pattern may be a hyperlink. Thus, for example, clicking on any of the Experts in the display calls up a display of the Expert. Both the end-user and data provider can modify the contents of the Favorites Pattern, for example by utilizing button 126 to add an Entity or button 128 to create a group. Furthermore, the end user may be notified of recent Content associated with the Experts in his or her Favorites Pattern using similar means to that of the Category/Watch List, described previously.

Producer/Reseller Interface

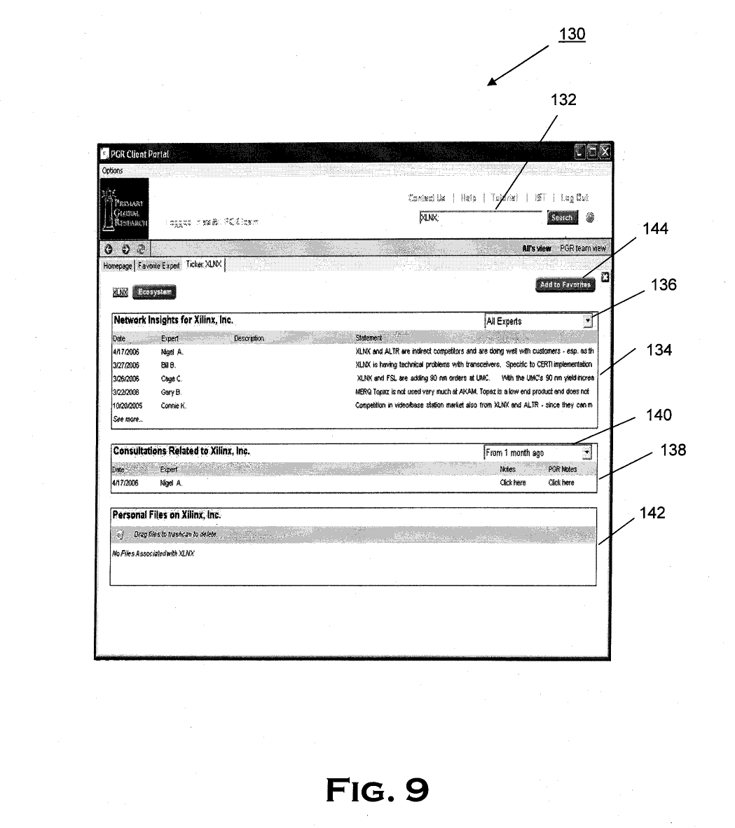

The Producer/Reseller interface allows the end user to view all research he or she has performed on a particular Product/Reseller. An exemplary Producer/Reseller Aggregation interface 130 is shown in FIG. 9 for a Product/Reseller, for example, in search tool 132. Interface 130 may display a number of Entities and/or Patterns related to the selected Product/Reseller, each providing certain content or information (e.g., Consultations). In addition, an interface 142 for attaching (e.g., by drag-and-drop, or other functionality) and accessing personal files associated with the user's data mosaic may be provided.

A first window 134 presents a list of all Consultations (collectively referred to as Network Insights in this example) for the Product/Reseller to which the user is permitted access. The Network Insights displayed in window 134 may be sorted by date, identity of the expert, age, etc. through an appropriate selection mechanism such as a pull-down menu 136.

A second window 138 presents a list of Consultations associated with the Product/Reseller to which the user is permitted access. These Consultations may have been entered by the user or by some other research provider. The Consultations displayed in window 138 may be sorted by date, Expert, age, etc. through an appropriate selection mechanism such as a pull-down menu 140.

A third window 142 presents a list of personal files the user has accumulated related to the Product/Reseller. These personal files include word processing documents, spreadsheets, images, multimedia files etc. which the user chooses to associate with the Product/Reseller. Typically, only the user would have access to such personal files, although access may be controlled (e.g., allowing access within a network, etc.) by permissions as well understood in the art.

The Product/Reseller interface 130 also provides the user with the ability to conveniently add the selected Product/Reseller to a Favorites/Categories list of a type described above. When viewing a Product/Reseller the user may selected the Add to Favorites button 144, which causes the Product/Reseller to be added to the user's Favorites/Categories List for Products/Resellers.

In addition, the interface allows the user to traverse the Value Chain Model to reach other related Entities of interest. Specifically, the Producer/Reseller Interface allows the end user to reach the following related Entities and/or Patterns efficiently:
1) Impact Statements (Content) made by other Experts (Content Sources) associated with this Producer/Reseller;
2) Previous Consultations (Aggregate Entities) done by the end user associated with this Producer/Reseller;
3) Additional Data Content owned by the end user associated with this Producer/Reseller.
   Optionally, the Producer/Reseller Interface may also include the following:
4) The ability to invoke the Ecosystem Interface (using button 146, and discussed further below), which allows the end user to traverse along the Value Chain Model to other related Producers/Resellers of interest.
5) Other Aggregations/Abstractions (e.g., instantiations of the Thesis Pattern) which are relevant to the Producer/Reseller.

Expert Entity and Interface

The Expert Entity is a subclass of Content Source, usually an individual, hence

expertεCS

The Expert interface allows the end user to view all Content previously developed by the Expert. FIG. 10 is an exemplary embodiment of an Expert interface 150. Interface 150 presents a biography window 152 which may provide biographic information, notes, etc. about the expert. Window 154 may be provided for displaying Notes entered by the data service provider, the user, third parties, etc. (as illustrated by window 62, FIG. 5). Additionally, the Expert interface 150 may provide Expert's Network Insights window 156, providing a user with a listing of Network Insights obtained from or provided by the Expert. Finally, interface 150 allows the end user to generate a new Consultation associated with the Expert (button 158), as well as to add the Expert to instantiations of the Favorites/Categories Pattern (button 160).

Ecosystem Interface

The Ecosystem Interface allows the end user to traverse the Value Chain Model, from Producer/Reseller to related Producer/Reseller. For a given Producer/Reseller, related Producers/Resellers are put into one or more of three categories: Supplier, Customer, and Competitor. Furthermore each of these categories may be broken down into subsets relevant to a class of Goods/Services associated with the Producer/Reseller. Such organization may be structured by the data service provider, by the user, or by third parties, as controlled by permissions, depending on the application of the present invention.

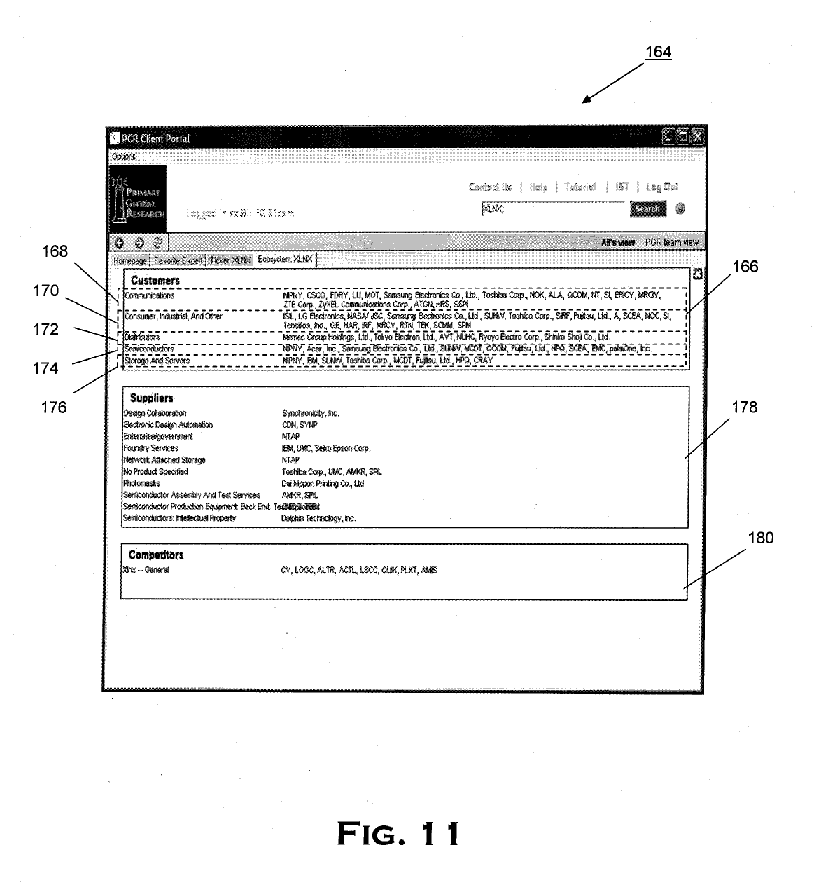

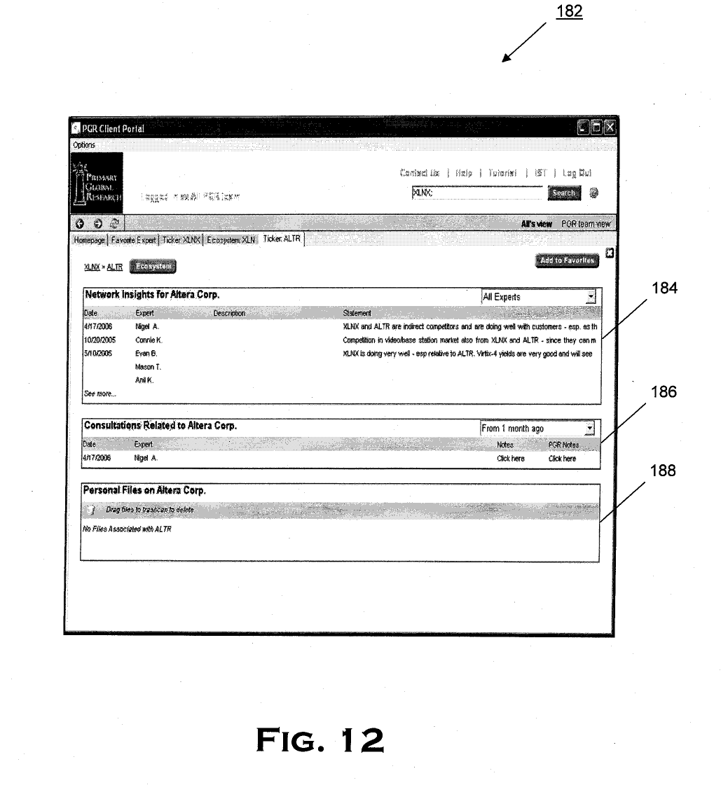

FIG. 11 illustrates an exemplary embodiment 164 of an Ecosystem interface. The Customers window 166 is broken down into categories 168-176 (i.e. Aggregate Entities of Goods/Services). Each Entity in the categories 168-170 may be a hyperlink, such that clicking on any of the ticker symbols representing a Producer/Reseller brings up an interface 182 of that Producer/Reseller, such as that illustrated in FIG. 12 (for ALTR), containing for example an insights interface 184, a consultations interface 186 and personal files interface 188 specifically related to the original company (XLNX). That is, entries in interfaces 184, 186, and 188 reference both the original company (XLNX) and the company whose link has been selected (ALTR). A similar display and functionality may be provided for related Suppliers in window 178 and Competitors in window 180.

### DETAILED EXAMPLES

User-Driven Traversal of the Value Chain Model

In this section we provide an example of a user-driven formation of a Data Mosaic. We select for this example a product category of audio/video players, and more specifically such products manufactured by Apple, Inc. (AAPL). The products, company, and details of the example are selected to provide an overview of certain of the features and capabilities of a system according to the present invention, and are not in any way limiting as to the fuller scope of the present invention.

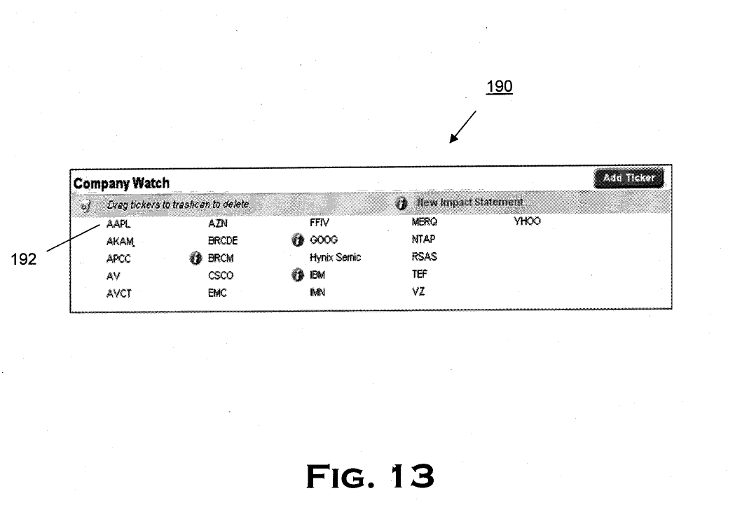

Once settled on a product and/or company a user wishes to investigate, the first step may be to refer to the Producer/Reseller Watch List Interface 190 shown in FIG. 13. As described above, the Watch List pattern contains a set of Producer/Reseller entities. In this specific embodiment, new Content pertinent to specific Producer/Resellers is shown with an “i” icon next to the ticker symbol or name of the Producer/Reseller, as is the case with BRCM, GOOG, and IBM.

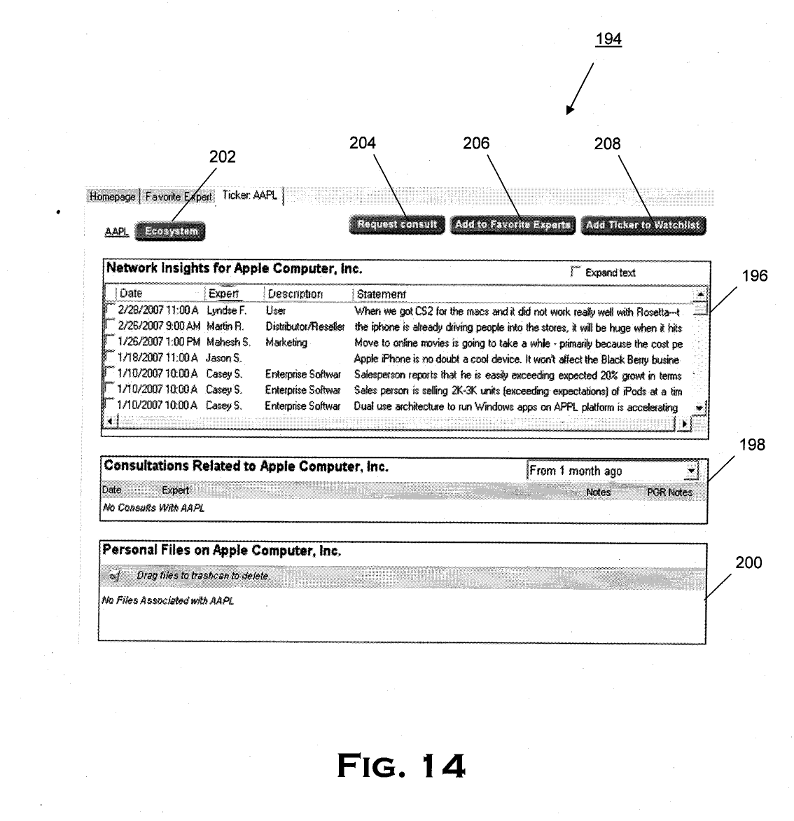

To investigate AAPL, the user clicks on the AAPL link 192, which brings the user to the Producer/Reseller interface 194, as shown in FIG. 14. This interface displays several different classes of entities linked directly to the AAPL Producer/Reseller, including:
1) The window 196 labeled “Network Insights for Apple Computer, Inc.” which displays a set of Content directly linked with AAPL (i.e., Statements), along with the Content Sources (i.e., Experts), date, and other data;
2) The window 198 labeled “Consultations Related to Apple Computer, Inc.” which displays an instantiation of a Consultation List Pattern relevant to the current user and AAPL (shown empty, but may be populated with any number of such Consultations);
3) The window 200 labeled “Personal Files on Apple Computer, Inc.” which provides a way of linking user-generated Content (in the form of files, presentations, spreadsheets, etc.) directly with the AAPL Producer/Reseller entity (shown empty, but may be populated with any number of personal files);
4) A Value Chain Model surrounding AAPL (not shown in FIG. 14, but viewable if the Ecosystem button 202 is selected);
5) A means of creating a Consultation entity for AAPL (the Request Consult button 204);
6) A means of adding the AAPL entity to the user's Favorites/Categories Expert list (the Add to Favorite Experts button 206, discussed and illustrated further below);
7) A means of adding the AAPL entity to the user's Producer/Reseller Watch List (the Add Ticker to Watchlist button 208, as shown in FIG. 14).

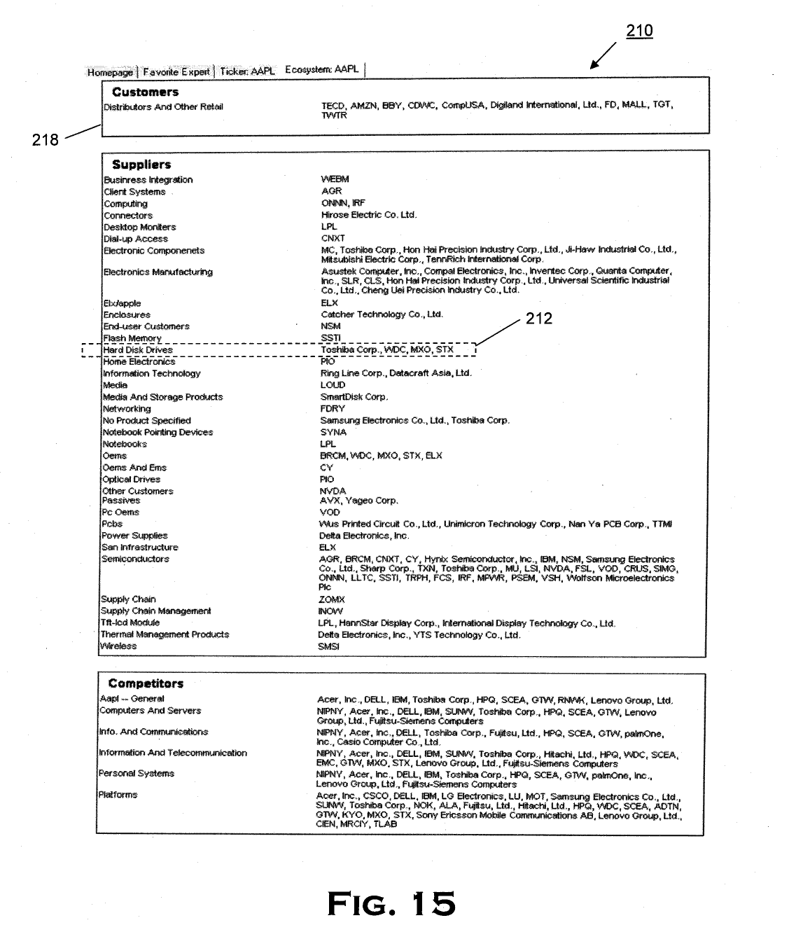

Suppose the user first wishes to browse AAPL's Value Chain Model interface, for example, to discover the various suppliers for AAPL's products. From Window 194, the user simply clicks on the Ecosystem button 202, which then links to and displays the Value Chain Model interface 210 shown in FIG. 15.

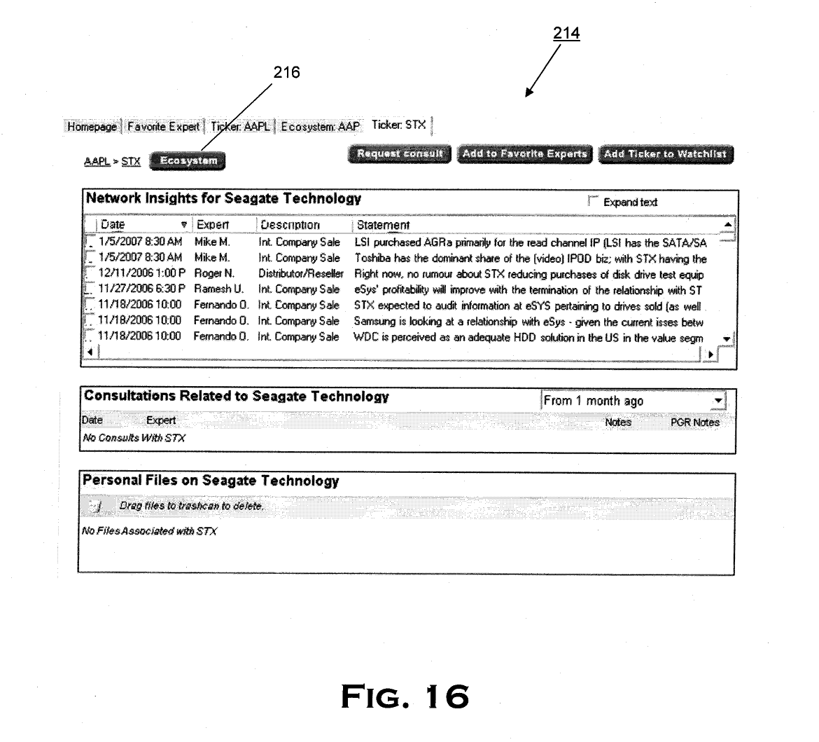

Value Chain Model interface 210 allows the user to browse through the customer, supplier, and competitor relationships for AAPL. For example, from interface 210 the user can see at 212 that there are four primary suppliers of hard drives for AAPL (i.e., Toshiba, WDC, MXO, STX). This suggests to the user that sales of AAPL products may result in changes in sales figures (and hence quarterly projections) for Toshiba, WDC, MXO, and STX, depending on the percentage of sales AAPL represents for the various vendors (information which could be located elsewhere in the VCM). Furthermore, since each entry in the VCM is itself a hyperlink, if the user clicks on, as an example, STX, the user then traverses to a Producer/Reseller interface 214 for STX shown in FIG. 16, which shows data within the union of APPL and STX. That is, the user can now view recent Content linked to both AAPL and STX.

Thus, the system uses the user's traversal through the Value Chain Model to provide targeted, relevant Content which helps to build out the user's actual or conceptual Data Mosaic. However, the user is completely in control of the traversals, allowing investigations of a wide variety of relationships and addressing of a variety of inquiries (theses). Furthermore, the user is able to create additional Entities and Patterns (e.g., Consultations, Producer/Reseller Watch List, Favorite Experts, etc.) during the exploration of the VCM. For example, in the case of Consultations, the user can annotate the Data Mosaic with his or her own interpretations of the Content offered by Content Sources.

At this point, the user could follow the STX Value Chain Model by clicking on the Ecosystem button 216 in FIG. 16. This action takes the user to the Value Chain Model interface for STX (not shown), allowing the user to traverse that Value Chain Model in a manner similar to that described above.

Using the above methodology, a user can very quickly investigate the Value Chain Model surrounding AAPL. As another example, a user may observe that there are few or only one supplier of potentially key components (“bottleneck suppliers”). For example, SSTI is the sole listed supplier of Flash memory to APPL. Through the traversal process described above it may be possible to determine how many other suppliers of Flash memory are in the market, and hence APPL's sensitivity to surpluses or shortfalls in the SSTI's production. As yet another example, returning to FIG. 15, if the user is interested in understanding how well AAPL is doing in terms of sales this quarter, the user can employ links provided in Customer window 218 to traverse to the Customers of AAPL: TECD, AMZN, BBY, CDWC, etc. Each traversal can provide additional data which the user can deploy in a Data Mosaic.

Thesis Traversal

The invention described in this patent also provides a language and means for structured interaction between a research provider and an end user for complex investment research concepts. The Thesis Pattern discussed above is a hierarchy of abstraction entities linked to both Content (both atomic and abstracted) and the Value Chain Model. This hierarchy and associated links are presented to the user and the user is allowed to traverse the model freely, while the system provides Content relevant to the user's focus of attention.

As an example, we select a Thesis relevant to AAPL such as the following:

Thesis: AAPL will dominate the mobile audio/video market for at least the next year.

Furthermore, we construct the following top-level Planks for the above:
1) Distributors and Resellers of AAPL audio/video players are experiencing strong sales growth in Q1 2007 and project strong growth through the end of the year.
2) Distributors and Resellers of competing audio/video players are experiencing weak to flat growth in market penetration.
3) Suppliers of electronic components to AAPL audio/video players have seen increasingly large orders for Q2 and Q3 2007.

### Plank 2) above could be divided into more specific sub-Planks:

2a) Sales of the Microsoft audio/video player have experienced weak to flat growth in market penetration;
2b) Sales of the Sony audio/video player have experienced loss of market share over the past several quarters.

### Plank 3) above could also be divided into more specific sub-Planks:

3a) 20 Gb and 40 Gb 2.5 inch hard drive suppliers WDC and STX have experienced strong orders over the past two quarters.
3b) 2″ LCD panel suppliers LPL and Hannstar have experienced strong orders over the past two quarters.
3c) Flash memory supplier SSTI has experienced strong order growth over the past two quarters.

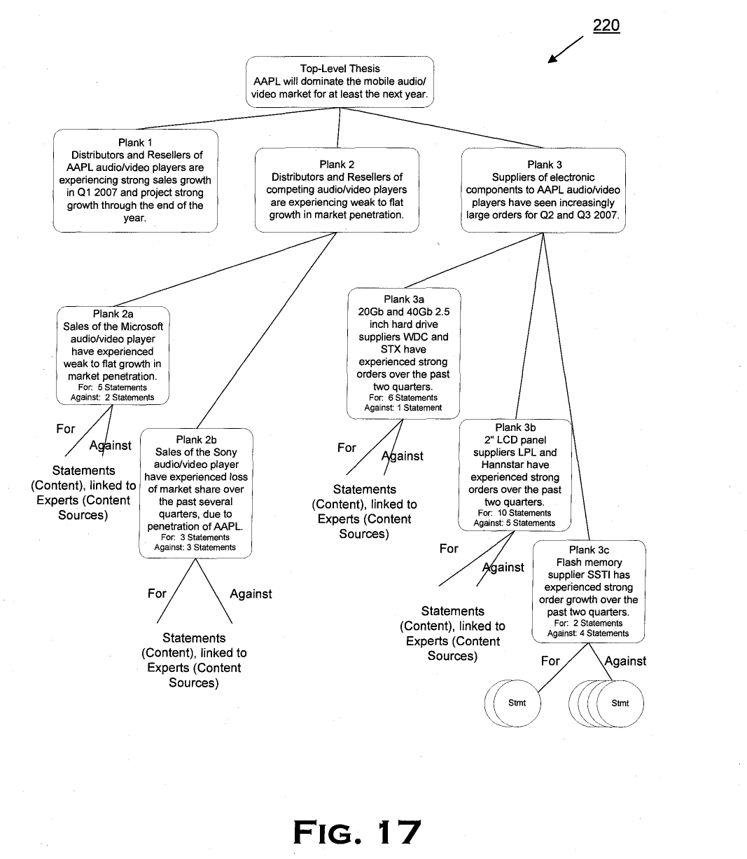

### The hierarchical structure 220 of the above Thesis is illustrated in FIG. 17.

Each of the Planks are Abstractions which are linked directly with Content (e.g. Statements) from Content Sources (e.g. Experts). In each of the supporting Planks (2a-2b, 3a-3c) the interface displays the number of Statements both supporting the Plank (For, or positive), opposing the Plank (Against, or negative), or Neither (neutral). (In certain embodiments it may be desirable to force rating statements as either For and Against a Plank.) Each Statement is also linked with a set of Producer/Resellers. The resulting Plank is therefore associated with the union of the sets of Producer/Resellers linked with the Statement (e.g., Plank 3c would be linked to SSTI, Plank 3b would be linked to LPL and Hannstar, and so on). Thus, the user can also traverse into the Value Chain Model surrounding AAPL from the Thesis.

The above Planks are examples of Abstractions—namely, the Planks 2a-2b, 3a-3c are abstractions generated from actual Statements (Content) originally obtained from Experts (Content Sources). Planks 2 and 3 are further abstractions of Planks 2a-2b and Planks 3a-3c, respectively. Finally, Planks 1-3 are finally abstracted into the top-level Plank displayed at the top of FIG. 17.

The hierarchical structure 220 illustrated in FIG. 17 may be rendered as a user interface on a user's computer display (FIG. 18). Elements of the interface may comprise hyperlinks, buttons, and/or clickable regions allowing the user to navigate using the interface. The advantage provided by this representation is that the user can start from anywhere in the abstraction hierarchy of the Thesis and browse upwards, sideways, and downwards through the hierarchy with the visual model acting as a form of map for the traversals. The “direction” of the traversals correspond to the hierarchy, for example:
1) Upwards—Based on Statements viewed on the AAPL Producer/Reseller page, find the set of Planks linked to the Statements and traverse to the different Theses linked to the Statements.
2) Sideways—Read through all the Planks associated with a Thesis.
3) Downwards—Start from the Top-Level Thesis and drill down to read the individual Statements made by Experts in support of or opposing all the Planks for the Thesis.

The user can also traverse between Theses, if they share Planks and/or Statements. Thus the Thesis pattern provides the means of a structured exploration of investment ideas between the research provider and end user.

### Scheduling Support

Central to the formation of a data mosaic for end users is the ability to schedule Consultations between the end users (e.g., Clients) and Content Sources (e.g., Experts) efficiently. Hence support for scheduling Consultations between end-users and Content Sources is an important capability for computer-based systems which support the primary research process described in this invention.

We define the Scheduling Problem as the problem of finding a common date, time, and location for an end user and Content Source to hold a conversation of given length. Inputs to the Problem include:

1) Scheduling Constraints

These are constraints (positive or negative) for dates/times (and possibly locations) for the Consultation from the end-user and/or the Content Source. Positive constraints are dates/times (and possibly locations) where the end-user or Content Source is available for the Consultation; negative constraints are dates/times (and possibly locations) where the end-user or Content Source is unavailable for the Consultation. The constraints may also include preferential information as well. Also, the desired length of the conversation and type of conversation (e.g. phone call, in-person meeting, social event, etc.) is included as a constraint.

2) Time Bound Constraints

These are constraints on the scheduling process itself and may be either Consultation-specific or Global in nature. Some examples of this type of constraint are:
a) A Consultation must be scheduled within x hours of request issued.
b) A Client/Expert must respond within y hours of receiving a request for constraints or a confirmation of a schedule.
c) There should be only z Request/Refine iterations before convergence on a schedule for a Consult.

Other types of Time Bound Constraints are also possible. There are a number of actions a system may take when a time bound constraint is violated. For example, the system may issue an automated warning to the Research Provider regarding the violated constraint. The Research Provider would then be able intervene in the scheduling process for this Consultation in a variety of ways (e.g., calling the non-responsive party or parties, canceling the Consultation if no longer needed, etc.)

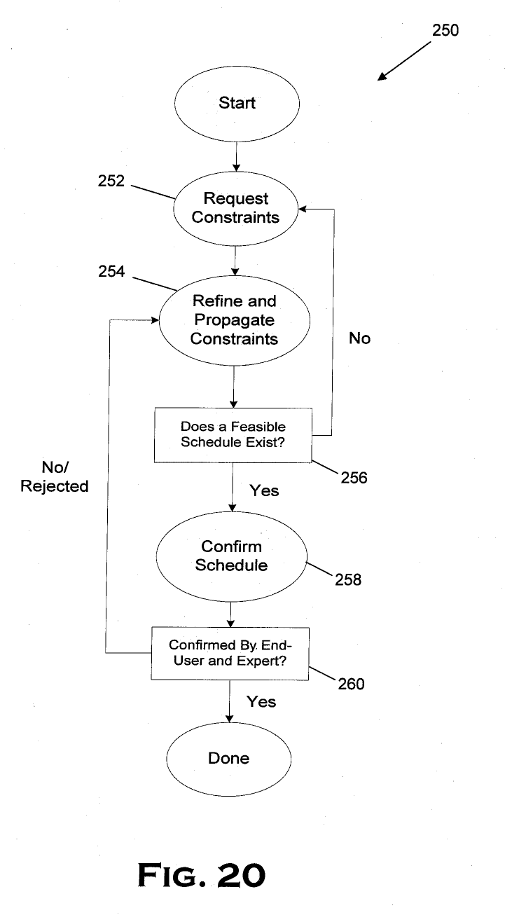

However, these constraints are often incomplete and/or unknown prior to the start of the scheduling process for a particular Consultation. Thus the process of scheduling is an iterative one. Such a process 250 is illustrated in FIG. 20, wherein the scheduling constraints of the end-user and Content Source are requested at 252 and are refined/propagated at 254 within the scheduling solution space to find a feasible scheduling solution set at 256. When a feasible solution is found, it is proposed to both the end-user and Content Source at 258. If either party rejects the schedule at 260, the system then loops back into the iterative process to find another possible schedule. If no schedule is possible, then new scheduling constraints are requested from the end-user and Content Source. The overall process is continued until either a feasible schedule is found or a time bound constraint is violated.

Violation of the time bound constraints result in an automatic notification of the violation to the Research Provider. The Research Provider may examine the scheduling history for the consultation and intercede by inserting themselves into the scheduling process.

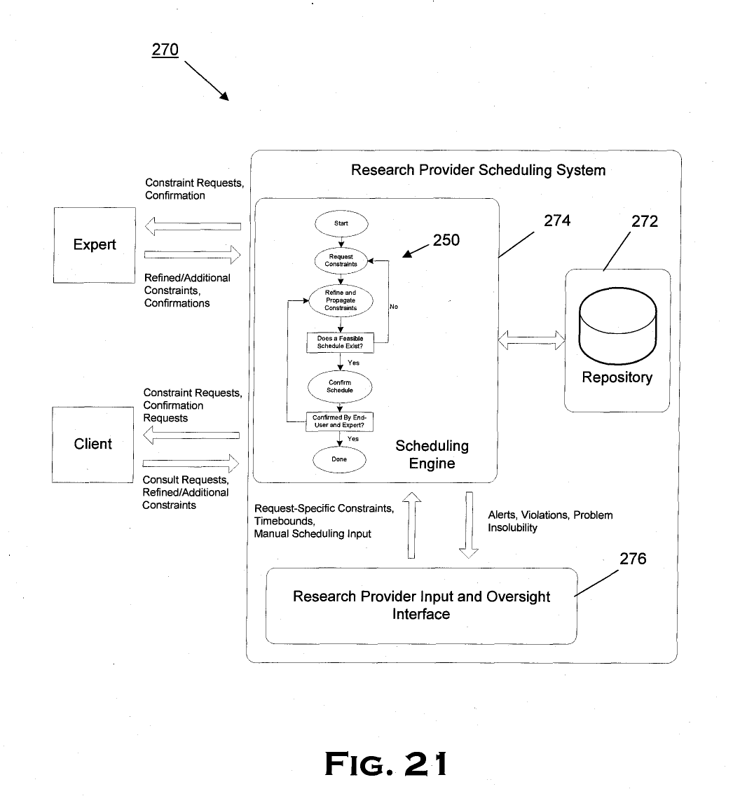

FIG. 21 describes a system 270 which implements the interaction model described above. The system has three core components:
1) A Repository 272 used to save all relevant scheduling data, constraints, Consultations, etc.;
2) A Scheduling Engine 274 which reads data from the Repository and implements the method 250 described in FIG. 20;
3) A Research Provider Input and Oversight Interface 276 which enables the Research Provider to examine the scheduling process for any Consultation, to add/modify Scheduling and Time Bound constraints, and to intervene in the scheduling process when appropriate. The interface also alerts the user (e.g. via email, graphical user display) when time bound constraints are violated or when other problem situations occur.

### The end-users and Content Sources exchange requests, constraints, and confirmations with the Scheduling System.

While a plurality of preferred exemplary embodiments have been presented in the foregoing detailed description, it should be understood that a vast number of variations exist, and these preferred exemplary embodiments are merely representative examples, and are not intended to limit the scope, applicability or configuration of the invention in any way. For example, the present invention may take the form of an application program running on a user's computer or network while making calls to a server and caching certain data to populate the application, or may take the form of a purely web-based, remote application. Furthermore, certain features described above may not be included in every embodiment of the present invention, and alternatively, other features supporting a decision making process not described above may be included without departing from the spirit and scope of the present invention. Therefore, the foregoing detailed description provides those of ordinary skill in the art with a convenient guide for implementation of the invention, by way of examples, and contemplates that various changes in the functions and arrangements of the described embodiments may be made without departing from the spirit and scope of the invention defined by the claims thereto.

What is claimed is:

1. A computer-implemented method of providing a decision assistance service related to market driven industries, comprising the steps of:
forming a database of producer/reseller entities;
forming a value chain model comprised of a plurality of said producer/reseller entities by linking together by a link entity at least two of said plurality of producer/reseller entities;
forming a market research model by creating at least one content entity, and linking said content entity by a link entity to one of said producer/reseller entities forming said value chain model; and
displaying to a user, through an interface, a view of the market research model, said interface permitting the user to navigate the market research model by selecting a producer/reseller entity or a content entity.

2. The method of claim 1, wherein each link entity is a hyperlink.

3. The method of claim 1, further comprising forming in said database at least one goods/services entity, and wherein said step of forming said value chain model further comprises the step of linking together by a link entity said at least one goods/services entity and at least one of said plurality of producer/reseller entities.

4. The method of claim 1, wherein each said link between said producer/reseller entities, between said goods/services entities and between said producer/reseller entities and said goods/services entities defines a type of relationship therebetween.

5. The method of claim 4, wherein each said link defining a relationship is displayable in said interface.

6. The method of claim 1, further comprising the step of linking together by hyperlink said market research model and a second value chain model.

7. The method of claim 1, further comprising the step of linking at least one content source entity to one content entity.

8. The method of claim 7, further comprising the step of linking to a producer/reseller entities or goods/services entity each said content source entity linked to a content entity.

9. The method of claim 7, further comprising forming, as a favorite experts entity, an aggregation entity comprised of a plurality of content source entities, each such content source entity linked to at least one of said content entities, said producer/reseller entities, or said goods/services entities.

10. The method of claim 9, further comprising the step of automatically notifying an end user when new content linked to a content source in the favorite experts entity is linked to the market research model.

11. The method of claim 7, further comprising the step of forming, as a watchlist entity, an aggregation entity comprised of a plurality of entities selected from said producer/reseller entities.

12. The method of claim 11, further comprising the step of automatically notifying an end user when new content linked to an entity in the watchlist entity is linked to the market research model.

13. The method of claim 7, further comprising the step of forming, as a categories entity, an aggregation entity comprised of a plurality of entities selected from either producer/reseller entities, goods/services entities or both.

14. The method of claim 13, wherein at least two of said entities comprising said categories entity are linked together by a link entity.

15. The method of claim 1, further comprising the step of forming, as a plank entity, an abstraction entity to which at least two content entities are linked, and further comprising the step of identifying each content entity linked to said plank entity as either “for” or “against” the plank entity.

16. The method of claim 15, further comprising the step of identifying said plank entity as “neutral” in place of identifying said entity as either “for” or “against” the plank entity.

17. The method of claim 15, further comprising the step of forming a second plank entity and link entity between said plank entity and said second plank entity.

18. The method of claim 15, further comprising forming, as a thesis entity, an abstraction entity having linked thereto a plurality of plank entities.

19. The method of claim 18, further comprising the step of generating, for a thesis entity, a display of the count of “for” labels and “against” labels of content entities linked to planks which are linked to the thesis entity.

20. The method of claim 19, further comprising the step of generating, for said thesis entity, a display of the count of “neutral” labels in addition to the count of “for” labels, “against” labels, of content entities linked to planks which are linked to the thesis entity.

21. The method of claim 1, further comprising displaying, to a third party, said market research model, and providing an interface permitting said third party to create a content entity and link said content entity to an element of said market research model.

22. The method of claim 21, further comprising the step of automatically creating a content source entity for said third party, and linking said third party content source entity to said third party-created content entity.

23. The method of claim 1, further comprising the step of receiving, from the user, a request to establish a consultation with a content source, and in response thereto, communicating with said content source and said user to establish a mutually acceptable time and manner to have such consultation.

24. The method of claim 1, further comprising the step of automatically notifying an end user when changes are made to the market research model.

25. A computer-implemented system for storing, displaying and navigating data regarding market driven industries, comprising:
a memory device, having stored thereon a research provider database, organized as a market research model, comprising at least one link entity and a plurality of producer/reseller entities organized into a value chain model such that at least two of said plurality of producer/reseller entities are linked together by said link entity;
a server communicatively coupled to said memory device, said server operating to:
provide a host research provider interface into said database for viewing a display of the producer/reseller entities, content entity, and link entity, and by which a host research provider may edit existing or create new producer/reseller entities, content entities, and link entities between said producer/reseller entities or between a producer/reseller entity and a content entity; and
provide an end user interface into said database for viewing a display of the producer/reseller entities, content entity, and link entity, and by which an end user may edit existing or create new content entities and link entities between said producer/reseller entity and a content entity or between two said content entities.

26. The computer-implemented system of claim 25, wherein said host research provider and end user interfaces further provides a view of, and the ability to edit an existing or create a new content source entity, and a link entity between a producer/reseller entity and said content source entity or between said content and said content source entity.

27. The computer-implemented system of claim 26, wherein said host research provider and end user interfaces further provide a view of, and the ability to edit an existing or create a new:
watchlist entity, comprising a plurality of entities selected from said producer/reseller entities;
categories entity comprised of a plurality of entities selected from either said producer/reseller entities, a plurality of goods/services entities or both;
plank entity to which at least two content entities are linked; and
thesis entity to which at least two said plan entities are linked.

28. The computer-implemented system of claim 25, wherein said server further operates to provide a third party research provider interface into said database for viewing a display of the producer/reseller entities, content entity, and link entity, and by which a third party research provider may edit existing or create new content entities and link entities between a producer/reseller entity and a content entity.

29. The computer-implemented system of claim 25, wherein said server further operates to permit said host research provider and said end user to schedule a consultation with a content source, said server further operating to facilitate communication between said content source and said host research provider or said end user to schedule a mutually acceptable time for and manner of communicating.

30. The computer-implemented system of claim 25, wherein said server is communicatively coupled to the internet, and whereby said host research provider interface and said user interface may be accessed via the internet.

31. The computer-implemented system of claim 25, wherein market research model further comprises at least one goods/services entity linked to at least one of said producer/reseller entities.

32. The computer-implemented system of claim 25, wherein said host research provider interface and said end user interface further provide a view of said producer/reseller entities and content entities as hyperlinks, allowing navigation to a second entity linked to a first entity when a user clicks on said first entity.

33. The computer-implemented system of claim 32, wherein each said link between said producer/reseller entities defines and displays a type of relationship therebetween.

34. A computer-implemented model for organizing data about accompany and its associated security, comprising:
an entity set comprising:
a value chain model representing the flow of goods or services between a first party and a second party;
a content entity concerning each of said first and second parties;
a content source indicating the source of said content entities concerning each of said first and second parties;
a link entity connecting in the model said first and second parties;
a user interface for display of said model such that each said first and second parties are represented by a hyperlink, whereby selection of said first party produces a display of content concerning said first party, and whereby further selection of said second party produces a display of content concerning both said first party and said second parties.

35. The computer-implemented model of claim 34, wherein said model further comprises an aggregation of entity sets.

36. The computer-implemented model of claim 34, wherein said model further comprises an abstraction of an entity set.

37. The computer implemented model of claim 34, wherein said value chain model further includes at least one element selected from the group consisting of:
a description of goods and services provided to either said first or second parties;
a description of relationships between additional parties and said first or second parties;
a description of relationships between suppliers of goods to either said first or second parties; and
a description of relationships between goods provided to either said first or second parties.

38. The computer implemented model of claim 34, further comprising annotation associated with one or more of said first and second parties, said value chain model, said content entity, said content source, and said link entity.

39. The computer implemented model of claim 34, wherein said content has associated therewith a rating of either positive, negative, or neutral.

40. A method of providing an interface to a computer-implemented model for organizing data about a company and its associated security, comprising:
storing in a computer-readable memory an entity set comprising:
a value chain model representing the flow of goods or services between a first party and a second party;
a content entity concerning each of said first and second parties;
a content source indicating the source of said content entities concerning each of said first and second parties;
a link entity connecting in the model said first and second parties;
generating a user interface for display of said model such that each said first and second parties are represented by a hyperlink;
displaying, in response to a selection of said first party a display of content concerning said first party; and
displaying, in response to a selection of said second party, and following said displaying of content concerning said first party, content concerning both said first party and said second parties.

41. The method of claim 40, further comprising the step of storing an annotation associated with one or more of said first and second parties, said value chain model, said content entity, said content source, and said link entity.

42. A method of providing research results relating to a company and its associated security to a user comprising the steps of:
storing, in a server, a market research model comprising:
a plurality of producer/reseller entities;
a plurality of goods/services entities;
a link entity between each of said producer/reseller entities and at least one other of said producer/reseller entities or said goods/services entities;
a link entity between each of said goods/services entities and at least one other of said producer/reseller entities or said goods/services entities;
at least one content entity associated with one of said producer/reseller entities or said goods/services entities;
a link entity associating said content entity and said associated one of said producer/reseller entities and said goods/services entities;
a content source indication for and associated with said at least one content entity;
a link entity associating said content source and said associated content entity;
displaying each of said producer/reseller entities and said goods/services entities, said at least one content entity, and said associated content source as hyperlink entities; and
whereby, selecting one of said hyperlink entity presents an interface listing all entities associated with the selected one of said producer entities and said goods/services entities.

43. The method of claim 42, wherein at least one of said at least one content entity comprises a consultation entity.

44. The method of claim 43, wherein said consultation entity is further categorized as either positive, negative, or neutral with regard to said associated one of said producer/reseller entities or goods/services entities.

45. The method of claim 42, further comprising the step of displaying each of said producer entities grouped together and each of said goods/services entities grouped together.

46. The method of claim 42, wherein each of said links between said producer/reseller entities, said goods/services entities, and said at least one other of said producer/reseller entities, said consumer entities, or said goods/services entities represents a relationship of a type selected from the group comprising: produced by, consumed by, supplier to, customer of, and partner with.
